(19) United States
(12) Patent Application Publication
(10) Pub. No.: US 2009/0086633 A1
(43) Pub. Date: Apr. 2, 2009

(54) Using A Link-State Advertisement To Inform Nodes Of The Availability Of Traffic Management Resources

(76) Inventors: Chenjiang Hu, Plano, TX (US); Calvin Wan, Plano, TX (US); Ronald P. Folkes, Dallas, TX (US)

Correspondence Address: BAKER BOTTS L.L.P., 2001 ROSS AVENUE, SUITE 600, DALLAS, TX, 75201-2980, US

(21) Appl. No.: 11/865,771

(22) Filed: Oct. 2, 2007

(51) Int. Cl. H04L 12/66

(52) U.S. Cl. 370/232; 370/401

(57) ABSTRACT

In one embodiment, informing nodes of traffic management resource availability includes determining a number of available traffic management resources at a first node, where a traffic management resource tracks usage of bandwidth by a tunnel at the first node. The number of available traffic management resources is recorded in a link-state advertisement. The link-state advertisement is sent to one or more second nodes.

### TECHNICAL FIELD

This invention relates generally to the field of communication networks and more specifically to using a link-state advertisement to inform nodes of the availability of traffic management resources.

### BACKGROUND

Communication networks may include tunnels through which nodes can communicate packets. In certain systems, a tunnel is assigned a traffic management resource (TMR) that limits the bandwidth used by the tunnel. A node typically has a fixed number of traffic management resources, so only a fixed number of tunnels can be configured through the node. In certain cases, a source node does not know the availability of traffic management resources at each node. If the source node attempts to set up a tunnel through a node that has no available traffic management resources, the tunnel set up fails.

### SUMMARY OF THE DISCLOSURE

In accordance with the present invention, disadvantages and problems associated with previous techniques for utilizing traffic management resources may be reduced or eliminated.

In one embodiment, informing nodes of traffic management resource availability includes determining a number of available traffic management resources at a first node, where a traffic management resource tracks usage of bandwidth by a tunnel at the first node. The number of available traffic management resources is recorded in a link-state advertisement. The link-state advertisement is sent to one or more second nodes.

Certain embodiments of the invention may provide one or more technical advantages. A technical advantage of one embodiment may be that a node informs other nodes of traffic management resource availability at the node. The node sends a link-state advertisement that indicates the number of available traffic management resources. Another technical advantage of one embodiment may be that a source node can use the traffic management resource availability information to select nodes to set up a tunnel.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system in which a node may inform other nodes of the availability of traffic management resources at the node;

FIG. 2 illustrates an example of an intermediate node that may be used with the system of FIG. 1;

FIG. 3 illustrates an example of a source node that may be used with the system of FIG. 1; and

FIG. 4 illustrates an example of a method for informing nodes of the availability of traffic management resources that may be used by system of FIG. 1.

### DETAILED DESCRIPTION OF THE DRAWINGS

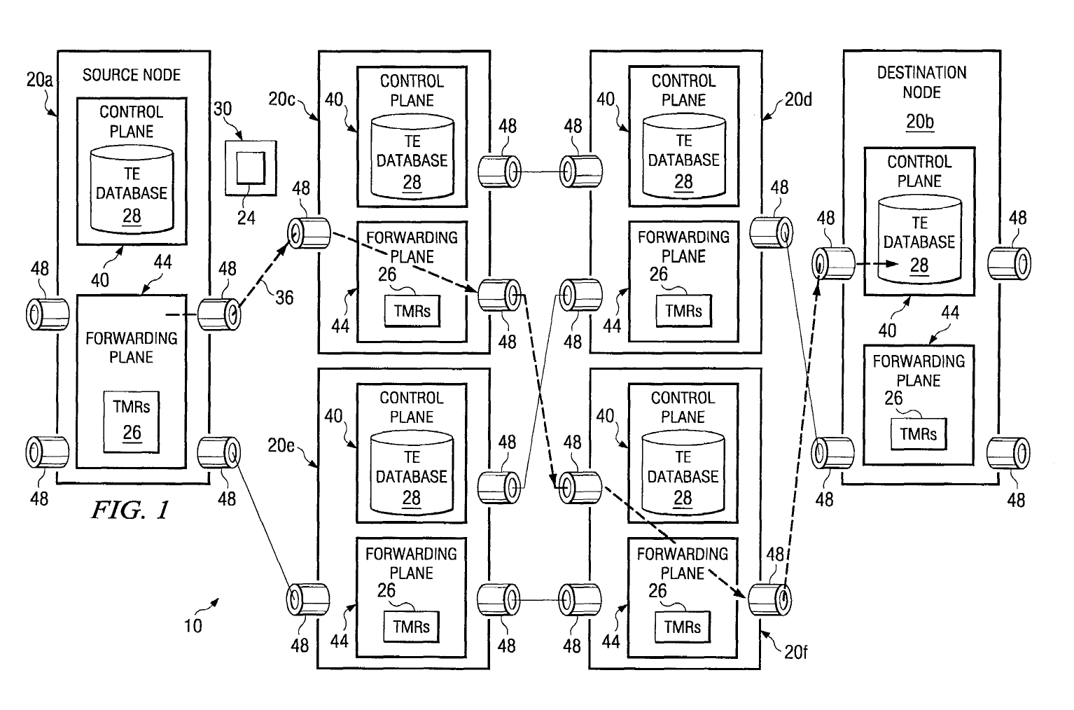

Embodiments of the present invention and its advantages are best understood by referring to FIGS. 1 through 4 of the drawings, like numerals being used for like and corresponding parts of the various drawings.

FIG. 1 illustrates an example of a system 10 in which a node 20 may inform other nodes 20 of the availability of traffic management resources 26 at the node 20. In the example, a node 20c sends a message 30 that includes traffic management resource availability (TMR) information 24. Message 30 comprises a link-state advertisement that provides TMR availability information 24. TMR availability information 24 indicates the number of available traffic management resources. A source node 20a can use the TMR availability information 24 to select nodes 20 to set up a tunnel 36.

In one embodiment, system 10 communicates information through signals such as optical signals. An optical signal may have any suitable data rate. Information may include voice, data, audio, video, multimedia, control, signaling, and/or other information.

In the illustrated example, system 10 includes nodes 20a-20f through which tunnel 36 may be set up. A node 20 may represent a Label Switching Router (LSR). A tunnel 36 may be a label switched path (LSP) that includes a sequence of nodes 20. Packets travel from a source node 20a, through zero, one, or more intermediate nodes 20c and 20f, to a destination node 20b. In one embodiment, source node 20 encapsulates packets in Multi-Protocol Label Switching (MPLS) packets. Intermediate nodes 20c and 20f forward packets based on the MPLS encapsulation. Destination node 20b de-encapsulates the MPLS packets to yield the original packets.

A node 20 includes a control plane 40, a forwarding plane 44, and ports 48. Control plane 40 determines the path of tunnel 36 to destination node 20b. Control plane 40 sets up a routing table that specifies ports 48 through which packets for destination node 20b should be routed. Control plane 40 includes a traffic engineering database 28 that stores traffic management information, such as TMR availability information 24 of nodes 20.

Forwarding plane 44 forwards packets according to the routing table. Forwarding plane 44 includes traffic management resources (TMRs) 26. A traffic management resource 26 is assigned to a particular tunnel 36 and is used to ensure that the traffic going through tunnel 36 does not exceed the bandwidth reserved for tunnel 36.

TMR availability information 24 for a node 20 describes the availability of traffic management resources 26 of node 20 for use by tunnels 36. The availability may indicate, for example, whether a traffic management resource is available at node 20 or the number of available traffic management resources at node 20.

A node 20b informs other nodes 20 (including source node 20a) of the availability of traffic management resources 26 by sending a message 30 that includes TMR availability information 24. In one embodiment, TMR availability information 24 describes the number of available traffic management resources 26 at node 20b.

TMR availability information 24 is recorded in a link-state advertisement (LSA), such as a traffic engineering (TE) link LSA. TMR availability information 24 may be recorded in the LSA any suitable manner. In one embodiment, information 24 may be recorded as a traffic management resource (TMR) availability value. The TMR availability value may be encoded as a sub-type-link-value (sub-TLV) of a TE link LSA by extending an Interior Gateway Protocol (IGP).

Interior Gateway Protocol (IGP) extensions include an Open Shortest Path First-Traffic Engineering (OSPF-TE) extension and an Intermediate System to Intermediate System-Traffic Engineering (ISIS-TE) extension. In the OSPF extension, the format of the TMR availability value may be:

Type (2 octets): to be assigned.

Length (2 octets): 4 in octet.

Value (4 octets):
First two octets: the total number of tunnels 36 that can be supported by the traffic management resources 26; and
Second two octets: the number of tunnels 36 that can be currently assigned a traffic management resource 26.

In the ISIS extension, the TMR availability value format may be:

Type (1 octet): to be assigned.

Length (1 octet): 4 in octet.

Value (4 octets):
First two octets: the total number of tunnels 36 that can be supported by the traffic management resources 26; and
Second two octets: the number of tunnels 36 that can be currently assigned a traffic management resource 26.

A node 20 may send other messages, such as link state advertisement messages for link state updates. In one embodiment, node 20b sends updates to TMR availability information 24 in link state advertisement messages. To control the number of updates, a damping control mechanism like bandwidth update may be used to reduce the updates.

Node 20b may also send a notification to source node 20a if the lack of available traffic management resources 26 causes failure of tunnel 36 to be set up. The notification may include an error message that identifies the failure is due to the lack of available traffic management resources 26. The notification may be sent in a Resource Reservation Protocol (RSVP) path or reservation message.

A component of system 10, such as a node 20a-20f, may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic, and may be stored in memory. Certain logic, such as a processor, may manage the operation of a component. Examples of a processor include one or more computers, one or more microprocessors, one or more applications, and/or other logic.

A memory stores information. A memory may comprise a computer-readable storage medium, such as computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable storage medium.

Modifications, additions, or omissions may be made to system 10 without departing from the scope of the invention. The components of system 10 may be integrated or separated. Moreover, the operations of system 10 may be performed by more, fewer, or other components. Additionally, operations of system 10 may be performed using any suitable logic. As used in this document, “each” refers to each member of a set or each member of a subset of a set.

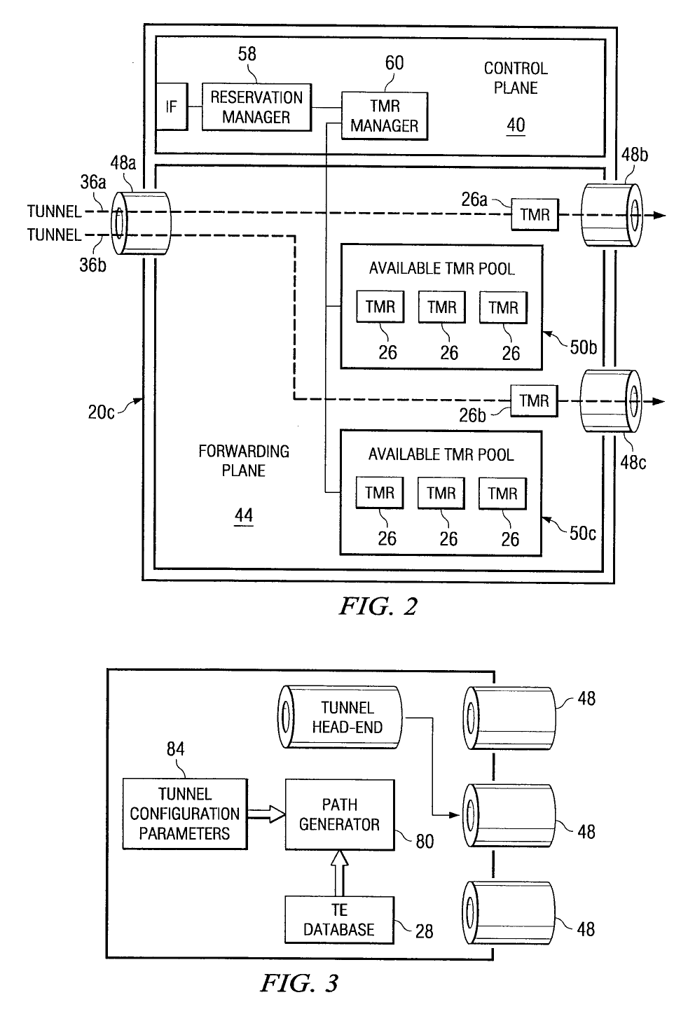

FIG. 2 illustrates an example of an intermediate node 20c that may be used with system 10 of FIG. 1. Node 20c includes ports 48a-48c, traffic management resources 26, TMR manager 60, and a reservation manager 58. Tunnel 36a traverses port 48a and port 48b, and tunnel 36b traverses port 48a and 48c.

Available TMR pool 50 includes traffic management resources 26 available at a particular port 48. Traffic management resources 26 that are in use (and thus not available) are located at tunnels 36. In the illustrated embodiment, tunnel 36a uses traffic management resource 26a, and tunnel 36b uses traffic management resource 26b.

Reservation manager 58 reserves resources for tunnels 36. TMR manager 60 tracks available traffic management resources 26 and assigns available traffic management resources 26 to tunnels 36. Reservation manager 58 checks with TMR manager 60 to determine if there is an available traffic management resource 26 before reserving resource 26.

TMR manager 60 determines TMR availability information 24, and records information 24 in message 30 for distribution to other nodes 20. In one embodiment, TMR manager 60y determines the number of available traffic management resources at node 20, and records the number as TMR availability value in a sub-TLV in a link-state advertisement.

Modifications, additions, or omissions may be made to node 20 without departing from the scope of the invention. The components of node 20 may be integrated or separated. Moreover, the operations of node 20 may be performed by more, fewer, or other components. For example, the operations of reservation manager 58 may be performed by more than one component. Additionally, operations of node 20 may be performed using any suitable logic.

FIG. 3 illustrates an example of source node 20a that may be used with system 10 of FIG. 1. Source node 20a includes a traffic engineering database 28, ports 48, and a path generator 80. Traffic engineering database 28 stores TMR availability information 24 that describes traffic management resources 26 available at nodes 20. Path generator 80 computes a path for tunnel 36, and may use a Constrained Shortest Path First (CSPF) technique to compute the path. Path generator 80 computes a path in accordance with tunnel configuration parameters 84. Tunnel configuration parameters 84 may designate the source node 20a of tunnel 36, destination node 20b of tunnel 36, and bandwidth required for tunnel 36.

In one embodiment, path generator 80 establishes that tunnel 36 requires a traffic management resource 26. Path generator 80 uses TMR availability information 24 from traffic engineering database 28 to select nodes 20 that have an available traffic management resource 26. In an equal-cost multi-path routing situation, node 20 with more resource availability may be selected.

Modifications, additions, or omissions may be made to source node 20a without departing from the scope of the invention. The components of node 20a may be integrated or separated. Moreover, the operations of node 20a may be performed by more, fewer, or other components. Additionally, operations of node 20a may be performed using any suitable logic.

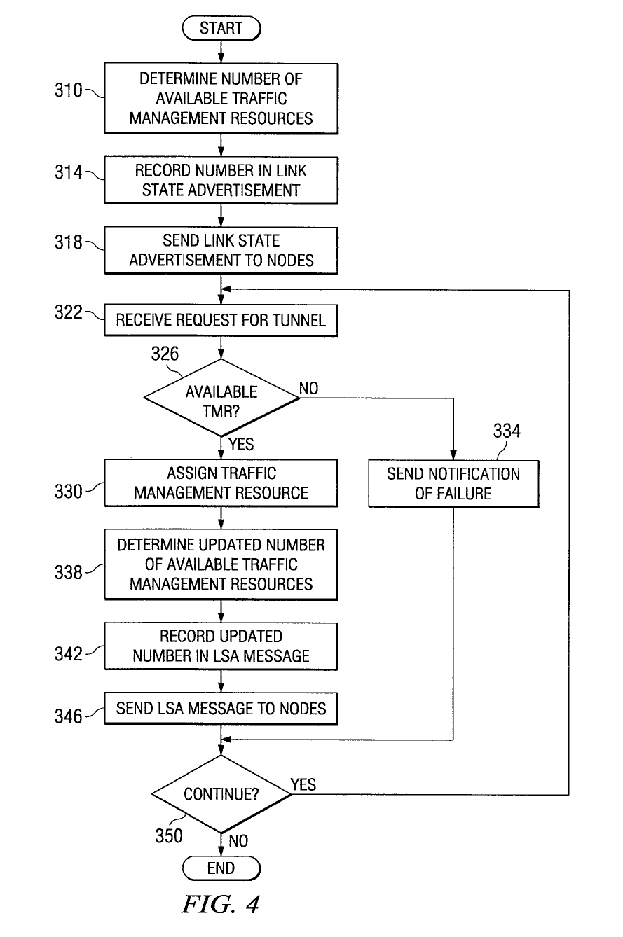

FIG. 4 illustrates an example of a method for informing nodes 20 of the availability of traffic management resources 26 that may be used by system 10 of FIG. 1. The method begins at step 310, where TMR manager 60 determines the number of available traffic management resources 26.

The number is recorded in a link-state advertisement at step 314 and placed in message 30. The link-state advertisement is sent to nodes 20 at step 318 in message 30. Nodes 20 (including source node 20a) stores TMR availability information 24 in traffic engineering database 28 at the node 20.

The number of available traffic management resources 26 is updated at step 338. The number is recorded in a link state advertisement message at step 342. The link state advertisement message is sent to the nodes 20 at step 346.

A request for a tunnel 36 is received at step 322. TMR manager 60 determines whether there is an available traffic management resource 26 at step 326. If there is an available resource 26, TMR manager 60 assigns the traffic management resource 26 at step 330. The method then proceeds to step 338. If there is no available traffic management resource 26 at step 326, the method proceeds to step 334, where TMR manager 60 triggers a notification that the set up of the tunnel 36 has failed because there are no available resources 26. TMR manager 60 may instruct reservation manager 58 to send the notification in an RSVP path or reservation message to the source node 20a of tunnel 36. The method then proceeds to step 350.

The method may be continued at step 350. If the method is to be continued, the method returns to step 322. If the method is not to be continued, the method terminates.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that a node informs other nodes of traffic management resource availability at the node. The node sends a link-state advertisement that indicates the number of available traffic management resources. Another technical advantage of one embodiment may be that a source node can use the traffic management resource availability information to select nodes to set up a tunnel.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method for informing one or more nodes of traffic management resource availability, comprising:
determining a number of available traffic management resources at a first node, a traffic management resource operable to track usage of bandwidth by a tunnel at the first node;
recording the number of available traffic management resources in a link-state advertisement; and
sending the link-state advertisement to one or more second nodes.

2. The method of claim 1, wherein recording the number of available traffic management resources further comprises:
recording the number in an Interior Gateway Protocol (IGP) extension.

3. The method of claim 1, wherein recording the number of available traffic management resources further comprises:
recording the number in an Open Shortest Path First-Traffic Engineering (OSPF-TE) extension.

4. The method of claim 1, wherein recording the number of available traffic management resources further comprises:
recording the number in an Intermediate System to Intermediate System-Traffic Engineering (ISIS-TE) extension.

5. The method of claim 1, further comprising:
determining an updated number of available traffic management resources at the first node; and
recording the updated number in a link state advertisement message.

6. The method of claim 1, further comprising:
receiving a request for a tunnel; and
assigning an available traffic management resource to the tunnel.

7. The method of claim 1, further comprising:
receiving a request for a tunnel when there are no available traffic management resources at the first node; and
sending a notification that there are no available traffic management resources at the first node.

8. An apparatus operable to inform one or more nodes of traffic management resource availability, comprising:
logic embodied in a memory and operable to:
determine a number of available traffic management resources at a first node, a traffic management resource operable to track usage of bandwidth by a tunnel at the first node; and
record the number of available traffic management resources in a link-state advertisement; and
an interface operable to:
send the link-state advertisement to one or more second nodes.

9. The apparatus of claim 8, the logic further operable to record the number of available traffic management resources by:
recording the number in an Interior Gateway Protocol (IGP) extension.

10. The apparatus of claim 8, the logic further operable to record the number of available traffic management resources by:
recording the number in an Open Shortest Path First-Traffic Engineering (OSPF-TE) extension.

11. The apparatus of claim 8, the logic further operable to record the number of available traffic management resources by:
recording the number in an Intermediate System to Intermediate System-Traffic Engineering (ISIS-TE) extension.

12. The apparatus of claim 8, the logic further operable to:
determine an updated number of available traffic management resources at the first node; and
record the updated number in a link state advertisement message.

13. The apparatus of claim 8, the logic further operable to:
receive a request for a tunnel; and
assign an available traffic management resource to the tunnel.

14. The apparatus of claim 8, the logic further operable to:
receive a request for a tunnel when there are no available traffic management resources at the first node; and
send a notification that there are no available traffic management resources at the first node.

15. Logic for informing one or more nodes of traffic management resource availability, the logic embodied in a computer-readable storage medium and when executed by a computer operable to:
determine a number of available traffic management resources at a first node, a traffic management resource operable to track usage of bandwidth by a tunnel at the first node;
record the number of available traffic management resources in a link-state advertisement; and
send the link-state advertisement to one or more second nodes.

16. The logic of claim 15, further operable to record the number of available traffic management resources by:
recording the number in an Interior Gateway Protocol (IGP) extension.

17. The logic of claim 15, further operable to record the number of available traffic management resources by:
recording the number in an Open Shortest Path First-Traffic Engineering (OSPF-TE) extension.

18. The logic of claim 15, further operable to record the number of available traffic management resources by:
recording the number in an Intermediate System to Intermediate System-Traffic Engineering (ISIS-TE) extension.

19. The logic of claim 15, further operable to:
receive a request for a tunnel when there are no available traffic management resources at the first node; and
send a notification that there are no available traffic management resources at the first node.

20. A system for informing one or more nodes of traffic management resource availability, comprising:
means for determining a number of available traffic management resources at a first node, a traffic management resource operable to track usage of bandwidth by a tunnel at the first node;
means for recording the number of available traffic management resources in a link-state advertisement; and
means for sending the link-state advertisement to one or more second nodes.
